(19) United States
(12) Patent Application Publication
(10) Pub. No.: US 2025/0130159 A1
(43) Pub. Date: Apr. 24, 2025

(54) A DEVICE FOR DETECTING PARTICLES IN FLUID AND A PROCESS FOR DETECTING SAID PARTICLES

(71) Applicant: PTT EXPLORATION AND PRODUCTION PUBLIC COMPANY LIMITED, Bangkok (TH)

(72) Inventors: Visarute PINROD, Pathum Thani (TH); Kittiphong THANA, Pathum Thani (TH); Paisan KHANCHAITIT, Pathum Thani (TH); Kittipong TANTISANTISOM, Pathum Thani (TH); Thitikorn BOONKOOM, Pathum Thani (TH); Yossawat RAYANASUKHA, Pathum Thani (TH); Sattra THONGMA, Pathum Thani (TH); Arachaporn ANUTTALIYA, Chon Buri (TH); Tanuspong POKAVANICH, Bangkok (TH); Naruchol PHOKAWAT, Bangkok (TH); Prasert PAVASANT, Bangkok (TH)

(21) Appl. No.: 18/705,451

(22) PCT Filed: Oct. 27, 2022
(86) PCT No.: PCT/IB2022/060318

§ 371 Date: Apr. 26, 2024

(30) Foreign Application Priority Data
Oct. 28, 2021 (TH) 2101006800

(51) Int. Cl. G01N 15/14; G01N 15/00; G01N 15/1409; G01N 15/1434

(52) U.S. Cl. CPC G01N 15/147; G01N 15/1409; G01N 15/1434; G01N 2015/0053; G01N 2015/1472

(57) ABSTRACT

A device for detecting particles in fluid and a process for detecting said particles according to the present invention are provided to detect particles in fluid using an optical technique consisting of electromagnetic sources which produce at least two wavelengths and are equipped with at least one polarizing sheet at any one of the electromagnetic sources. An electromagnetic wave directly obtained from the electromagnetic source and a polarized electromagnetic wave irradiate the particles detected in a detection region, which is provided in the same area with or connected to a container containing a medium fluid. Next to the detection region, a second polarizing sheet and a two-dimensional sensor array are provided in sequence. The electromagnetic waves which have passed through the second polarizing sheet irradiate the two-dimensional sensor array and the data obtained from said sensor will be processed by a processor to detect the particles and report the results.

### TECHNICAL FIELD

Engineering related to a device for detecting particles in fluid and a process for detecting said particles

### BACKGROUND OF THE INVENTION

The detection of particles and fluid was developed for applications in various fields, such as pharmaceuticals, chemistry, electronics, machinery, agriculture, environment, etc. Industries in which quality control in manufacturing is mandatory need to detect the particles and a group of fluid contaminated in the raw material and in the air all the time. In the pharmaceutical industry, if there are particles contaminated in the raw material or in the air, the drug obtained could be contaminated and deleterious to users. In the electronics industry, the manufacturing of integrated circuit (IC) requires a photoresist to create a circuit pattern. If there is a number of particles or a group of different fluid contaminated, the manufactured IC could be damaged. Moreover, the manufacturing needs to be carried out in a cleanroom where the dust content in the air is less than specified, it is thus mandatory to detect and control the amount of particles or a group of different fluid in the photoresist and in the air. In the industries using machines, the detection of the amount of metal particles in the oil can be carried out to measure the machines' deterioration. In the agricultural industry, the detection of the amount of plankton or aquatic animal offspring can be carried out to achieve effective aquatic animal breeding. The environmental quality inspection can be carried out using a particle counter to assist in the detection of microplastics in water sources or the detection of smoke from industrial plants.

There are various processes and systems for detecting particles and fluid, for example, an irradiation through a liquid containing particles while flowing through a capillary tube to measure the light intensity which the particles absorb or the fluorescence to count the particles which flow through. U.S. Pat. No. 8,524,489 B2, titled “Particle or cell analyzer and method”, discloses a method for detecting particle or cell, which are bacteria, viruses, DNA, cells, molecules, or constituents of whole blood. However, such US patent uses a general light intensity detection, the particles having similar size to the detection region thus can be detected only one at a time while flowing through the detection region. In case there are more than one particle in the detection region, or the particles are much smaller than the detection region, there may be an error in the detection. Additionally, there are other complex processes as shown in U.S. Pat. No. 8,427,642 B2, titled “Two-dimensional optical imaging methods and systems for particle detection” which discloses a method for detecting particles by exposing the particles moving through a tube to an electromagnetic wave using a two-dimensional sensor array to detect the intensity of the electromagnetic wave which is scattered or emitted from the particles, therefore the particles having a size similar to the detection region can be detected only one at a time while flowing through the detection region. In case there are more than one particle in the detection region, or the particles are much smaller than the detection region, there may be an error in the detection. In addition, this method cannot detect the particles which do not have the electromagnetic wave scattering or emission property.

Due to such technical limitations of the prior arts, the inventors came up with an idea to develop a device, a process, and a system for detecting particles in fluid which are capable of classifying at least two types or more of particles having different optical properties using the polarization technique by concurrently irradiating unpolarized electromagnetic wave or polarized electromagnetic wave having from two wavelengths (two-wavelength polarization), with each wavelength being at least 10 nm different from each other, at a detection region in order to differentiate the particles in a medium fluid, resulting in an interaction between the electromagnetic waves and the different particles and/or fluid in the classification of said particles and/or fluid. Microplastics in the sea are considered a crucial environmental problem which affects the environment and aquatic animals, as well as the health of aquatic animal consumers. The microplastic has a size from 1 μm to 5 mm. The large difference in the size range is a challenge for the microplastic detector designing technology. Since the low concentration microplastics in an amount of from 1-100 pieces/m³ are reported, a large amount of water is required in the detection. Moreover, due to most of the particles in the sea are plankton, the present invention is aimed at developing a detecting device to count and classify the particles into plankton and microplastics.

### SUMMARY OF THE INVENTION

A device for detecting particles in fluid and a process for detecting said particles according to the present invention are intended for detecting particles in fluid using an optical technique. The device comprises electromagnetic sources which produce at least two wavelengths and are equipped with at least one polarizing sheet at any one of the electromagnetic sources. An electromagnetic wave directly obtained from the electromagnetic source and a polarized electromagnetic wave are irradiated at the particles required to be detected in a detection region, which is provided in the same area with or connected to a container containing a medium fluid. Next to the detection region, a second polarizing sheet and a two-dimensional sensor array are provided in sequence. The electromagnetic waves which have passed through the second polarizing sheet are irradiated at the two-dimensional sensor array and the data obtained from said sensor will be processed by a processor to detect the particles and report the results.

The present invention is aimed at developing a device and a process for detecting particles, particularly microplastics, and characterized by the use of various optical interactions, i.e., light transmission, light absorption, light reflection, fluorescence, or light scattering, to develop the detecting device and enable the detection and classification of particles having different optical properties in a simultaneous and rapid manner, for example, the detection of microplastic particles and plankton particles in the sea water. The detection can be achieved for the particles having sizes up to 10,000 times smaller than the detection region. The detection of low-concentration particles can also be achieved as the detecting device is highly sensitive and can be used in the detection of particles in a medium fluid flowing through or at rest.

### BRIEF DESCRIPTION OF THE DRAWINGS

FIG. 1 shows an exemplary embodiment of a diagram of the device for detecting particles in fluid.

FIG. 2 shows another exemplary embodiment of a diagram of the device for detecting particles in fluid.

FIG. 3 shows exemplary images of the test results obtained from the detection using the two-dimensional sensor array upon irradiating an unpolarized parallel green light and a polarized red light to detect the microplastic particles and the plankton particles in the sea water.

FIG. 4 shows an exemplary embodiment of the processing of the data obtained from the two-dimensional sensor array by irradiating an unpolarized parallel blue light and a polarized green light.

### DETAILED DESCRIPTION

The present invention will be described by way of example with reference to the drawings for clearer exemplification and explanation. The same elements in these drawings are represented by the same reference numbers without limiting the scope of the claims in any way.

Any aspects shown herein shall encompass the applications to other aspects of the present invention as well, unless stated otherwise.

Technical and scientific terms used herein have the meanings as understood by a person of ordinary skill in the art, unless specified otherwise.

The terms “consist(s) of,” “comprise(s),” “contain(s)” and “include(s)” are open-ended verbs. For example, any method which “consists of,” “comprises,” “contains” or “includes” one or more components or one or more steps is not intended to be limited to only said one or more components or one or more steps but shall encompass components or steps that are not mentioned.

Any tools, devices, methods, materials, or chemicals mentioned herein, unless stated otherwise, shall mean the tools, devices, methods, materials, or chemicals generally used or practiced by a person skilled in the art.

All compositions, elements and/or methods disclosed and claimed in the present invention are intended to encompass the aspects of the invention obtained from any actions, practices, modifications or changes to the factors without experimentations that are significantly different from the present invention which result in properties and utility and give rise to effects similar to the aspects of the present invention according to the judgement of a person of ordinary skill in the art, although not specifically stated in the claims. Hence, equivalents or analogues of the aspects of the present invention include any slight modifications or changes which are apparent to a person of ordinary skill in the art and should be considered to be within the spirit, scope and concept of the present invention.

Particles 132, 142 refer to objects or substances which are insoluble in a medium fluid 122, such as microplastic particles or plankton particles in sea water, or oil in water, gas in water or suspension.

The details of the present invention will be described hereinafter with respect to the device for detecting particles in fluid and the process for detecting said particles.

The device for detecting particles in fluid comprises:
electromagnetic sources 216, 218 producing at least two different wavelengths and equipped with a first polarizing sheet 236 in a front region of any one of the electromagnetic sources 216, 218, an electromagnetic wave directly obtained from the electromagnetic source 240 and a polarized electromagnetic wave 241 being irradiated at a detection region 116;
the detection region 116 provided in the same area with or connected to a container containing fluid required in the detection, wherein said detection region 116 has a detection region wall 156, which allows the electromagnetic waves 240, 241 to irradiate therethrough and hit the particles 132, 142 detected in the medium fluid 122, and, next to the detection region 116, a second polarizing sheet 326 and a two-dimensional sensor array 316 provided in sequence, wherein the irradiation of the electromagnetic waves 240, 241 through the second polarizing sheet 326 produces an electromagnetic wave 336 used to irradiate the two-dimensional sensor array 316, said sensor 316 providing data which will be transmitted to a processor 400; and
the processor 400 provided to analyze the data obtained from the two-dimensional sensor array 316 from a single frame or multiple frames combined to detect the particles 132, 142 and subsequently report the results.

In a preferred embodiment of the invention, the electromagnetic waves 240, 241 are selected from any one of light wave, infrared wave, ultraviolet wave, or a combination thereof.

In a preferred embodiment of the invention, the electromagnetic waves 240, 241 are preferably the light wave having a wavelength ranging from 350-800 nm.

In a preferred embodiment of the invention, the electromagnetic wave directly obtained from the electromagnetic source 240 is preferably any one of a red-light wave having a wavelength of 620-750 nm, a green-light wave having a wavelength of 500-620 nm, or a blue-light wave having a wavelength of 350-500 nm.

In a preferred embodiment of the invention, the polarized electromagnetic wave 241 is preferably any one of a red-light wave having a wavelength of 620-750 nm, a green-light wave having a wavelength of 500-620 nm, or a blue-light wave having a wavelength of 350-500 nm.

In a preferred embodiment of the invention, the electromagnetic sources 216, 218 produce wavelengths that are at least 10 nm different from one another.

In a preferred embodiment of the invention, the electromagnetic sources 216, 218 produce wavelengths that are different from one another in a range of 10-1,000 nm.

In a preferred embodiment of the invention, the electromagnetic sources 216, 218 produce the electromagnetic waves 240, 241 that are parallel or nearly parallel to one another, the electromagnetic sources 216, 218 being selected from any one or more of halogen bulb, light bulb, laser, LED bulb, microwave sources, or a combination thereof.

In a preferred embodiment of the invention, the electromagnetic sources 216, 218 preferably adjust the electromagnetic waves 240, 241 such that they are parallel to one another using an optical composition selected from any one or more of lens, mirror, integrator rod, or a combination thereof.

In a preferred embodiment of the invention, a distance from the electromagnetic sources 216, 218 to the detection region 116 is 0-1.000 times greater than a thickness of the detection region to obtain the parallel or nearly parallel electromagnetic waves.

In a preferred embodiment of the invention, the electromagnetic sources 216, 218 are preferably 0-30 cm away from the detection region 116.

In a preferred embodiment of the invention, the electromagnetic waves 240, 241 from the electromagnetic sources 216, 218 are adjusted to have a suitable wavelength using the electromagnetic waves or the optical composition selected from any one or more of lens, mirror, filter, polarizer, prism, grating, slit, or a combination thereof.

In a preferred embodiment of the invention, the medium fluid 122 allows the electromagnetic waves to irradiate therethrough.

In a preferred embodiment of the invention, the medium fluid 122 contains different types of particles or fluid.

In a preferred embodiment of the invention, the medium fluid 122 has optical properties selected from any one or more of light absorption, light refraction, light reflection, fluorescence, light scattering, polarization, or a combination thereof.

In a preferred embodiment of the invention, the medium fluid 122 flows through or stays at rest in the detection region 116.

In a preferred embodiment of the invention, the particles 132, 142 have optical properties selected from any one or more of light absorption, light refraction, light reflection, fluorescence, light scattering, polarization, or a combination thereof.

In a preferred embodiment of the invention, the particles 132, 142 have a size ranging from 1 μm to 5 mm.

In a preferred embodiment of the invention, the detection region wall 156 is obtained from any one of transparent material or translucent material or a combination thereof.

In a preferred embodiment of the invention, the detection region wall 156 is preferably obtained from a material with no polarization axis distortion property.

In a preferred embodiment of the invention, the two-dimensional sensor array 316 is any one of a complementary metal oxide semiconductor (CMOS) or a charge coupled device (CCD) or a combination thereof.

In a preferred embodiment of the invention, the device for detecting particles in fluid further comprises at least one pump 402 which transmits the medium fluid 122 in a direction from the bottom to the top.

In a preferred embodiment of the invention, the device for detecting particles in fluid further comprises at least one pump 402 which draws the medium fluid 122 such that a flow direction of the medium fluid 122 makes a 0-45° angle with a gravity line in a position before the detection region 116.

In a preferred embodiment of the invention, the two-dimensional sensor array 316 transmits the data regarding any one of shape, size, intensity, wavelength, polarization, or a combination thereof to the processor 400 to detect the particles 132, 142.

In a preferred embodiment of the invention, the processor 400 is a device capable of analyzing the data, which is selected from any one or more of computer, mobile phone, cloud computing, application-specific integrated circuit (ASIC), field-programmable gate array (FPGA), embedded system, microcontroller, microprocessor, single-board computer, or a combination thereof.

In a preferred embodiment of the invention, the processor 400 processes and reports the data which are any one or more of types of particles, amount, volume, concentration, optical properties, phase of the particles 132, 142, or a combination thereof.

In a preferred embodiment of the invention, a sensor control unit 401 controls the operation and the parameters of the two-dimensional sensor array 316, which are ISO and integration time.

In a preferred embodiment of the invention, the sensor control unit 401 controls the operation and the parameters of the two-dimensional sensor array 316 by providing a suitable ISO in a range of 500-5,000,000 and a suitable integration time in a range of 100-10,000 μs.

In a preferred embodiment of the invention, the sensor control unit 401 is integrated with the processor 400 or separated from the processor 400.

In another embodiment, the process for detecting particles comprises the steps as follows:
a. providing different types of particles 132, 142 in the medium fluid 122 which flows through or stays at rest in the detection region 116;
b. irradiating the electromagnetic wave directly obtained from the electromagnetic source 240 and the polarized electromagnetic wave 241 having different wavelengths at the detection region 116 through the detection region wall 156 which allows the electromagnetic waves 240, 241 to irradiate therethrough and hit the particles 132, 142 detected in the medium fluid 122;
c. measuring the electromagnetic waves from an optical interaction of the particles 132, 142 which hits the two-dimensional sensor array 316; and
d. analyzing the data obtained from the two-dimensional sensor array 316 from a single frame of multiple frames combined using the processor 400 and reporting the results.

In a preferred embodiment of the invention, the process for detecting particles uses the electromagnetic waves 240, 241 which are selected from any one of light wave, infrared wave, ultraviolet wave, or a combination thereof.

In a preferred embodiment of the invention, the process for detecting particles uses the electromagnetic waves 240, 241 which are preferably a light wave having a wavelength ranging from 350-800 nm.

In a preferred embodiment of the invention, the process for detecting particles uses the electromagnetic wave directly obtained from the electromagnetic source 240 which are preferably any one of a red-light wave having a wavelength of 620-750 nm or a green-light wave having a wavelength of 500-620 nm or a blue-light wave having a wavelength of 350-500 nm.

In a preferred embodiment of the invention, the process for detecting particles uses the polarized electromagnetic wave 241 which is preferably any one of a red-light wave having a wavelength of 620-750 nm or a green-light wave having a wavelength of 500-620 nm or a blue-light wave having a wavelength of 350-500 nm.

In a preferred embodiment of the invention, the process for detecting particles uses the electromagnetic sources 216, 218 which produce wavelengths that are at least 10 nm different from one another.

In a preferred embodiment of the invention, the process for detecting particles uses the electromagnetic sources 216, 218 which produce wavelengths that are different from one another in a range of 10-1.000 nm.

In a preferred embodiment of the invention, the process for detecting particles uses the electromagnetic sources 216, 218 which produce the electromagnetic waves 240, 241 that are parallel or nearly parallel to one another, the electromagnetic sources 216, 218 being selected from any one or more of laser, diode, LED bulb, or a combination thereof.

In a preferred embodiment of the invention, the process for detecting particles uses the electromagnetic sources 216, 218 preferably adjust the electromagnetic waves 240, 241 such that they are parallel to one another using an optical composition selected from any one or more of lens, mirror, integrator rod, or a combination thereof.

In a preferred embodiment of the invention, the process for detecting particles uses the electromagnetic sources 216, 218 wherein the distance from the electromagnetic sources 216, 218 to the detection region 116 is 0-1,000 times greater than the thickness of the detection region 116 to obtain the parallel or nearly parallel electromagnetic waves.

In a preferred embodiment of the invention, the process for detecting particles uses the electromagnetic sources 216, 218 which are at least 5 cm away from the detection region 116.

In a preferred embodiment of the invention, the process for detecting particles uses the electromagnetic sources 216, 218 which are preferably 0-30 cm away from the detection region 116.

In a preferred embodiment of the invention, the process for detecting particles uses the electromagnetic sources 216, 218 wherein the distance from the electromagnetic sources 216, 218 to the detection region 116 is more than three times greater than the thickness of the detection region to obtain the parallel or nearly parallel electromagnetic waves.

In a preferred embodiment of the invention, the process for detecting particles uses the electromagnetic waves 240, 241 from the electromagnetic sources 216, 218, which are adjusted to have a suitable wavelength using the electromagnetic waves or the optical composition selected from any one or more of lens, mirror, filter, polarizer, prism, grating, slit, or a combination thereof.

In a preferred embodiment of the invention, the process for detecting particles uses the medium fluid 122 which allows the electromagnetic waves to irradiate therethrough.

In a preferred embodiment of the invention, the process for detecting particles uses the medium fluid 122 which contains different types of particles or fluid.

In a preferred embodiment of the invention, the process for detecting particles uses the medium fluid 122 which has optical properties selected from any one or more of light absorption, light refraction, light reflection, fluorescence, light scattering, polarization, or a combination thereof.

In a preferred embodiment of the invention, the process for detecting particles uses the medium fluid 122 which flows through or stays at rest in the detection region 116.

In a preferred embodiment of the invention, the particles 132, 142 in the process for detecting particles have optical properties selected from any one or more of light absorption, light refraction, light reflection, fluorescence, light scattering, polarization, or a combination thereof.

In a preferred embodiment of the invention, the particles 132, 142 in the process for detecting particles have a size ranging from 1 μm to 5 mm.

In a preferred embodiment of the invention, the process for detecting particles uses the detection region wall 156 which is obtained from any one of transparent material or translucent material or a combination thereof.

In a preferred embodiment of the invention, the process for detecting particles uses the detection region wall 156 which is preferably obtained from a material with no polarization axis distortion property

In a preferred embodiment of the invention, the process for detecting particles uses the two-dimensional sensor array 316 which is any one of a complementary metal oxide semiconductor (CMOS) or a charge coupled device (CCD) or a combination thereof.

In a preferred embodiment of the invention, the process for detecting particles further comprises at least one pump 402 which transmits the medium fluid 122 in the direction from the bottom to the top.

In a preferred embodiment of the invention, the process for detecting particles further comprises at least one pump 402 which transmits the medium fluid 122 such that the flow direction of the medium fluid 122 makes a 0-45° angle with the gravity line in a position before the detection region 116.

In a preferred embodiment of the invention, the process for detecting particles uses the two-dimensional sensor array 316 to transmit the data regarding any one of shape, size, intensity, wavelength, polarization, or a combination thereof to the processor 400 to detect the particles 132, 142.

In a preferred embodiment of the invention, the data obtained from the two-dimensional sensor array 316 is the data obtained from the electromagnetic wave 336.

In a preferred embodiment of the invention, the data obtained from the two-dimensional sensor array 316 is the data regarding any one of shape, size, intensity, wavelength, polarization, or a combination thereof to the processor 400 to detect the particles 132, 142.

In a preferred embodiment of the invention, the process for detecting particles uses the processor 400 which is a device capable of analyzing the data which is selected from any one or more of computer, mobile phone, cloud computing, application-specific integrated circuit (ASIC), field-programmable gate array (FPGA), embedded system, microcontroller, microprocessor, single-board computer, or a combination thereof.

In a preferred embodiment of the invention, the process for detecting particles uses the processor 400 to process and report the data which are any one or more of types of particles, amount, volume, concentration, optical properties, phase of the particles 132, 142, or a combination thereof.

In a preferred embodiment of the invention, the process for detecting particles further comprises the sensor control unit 401 which controls the operation and the parameters of the two-dimensional sensor array 316, which are ISO and integration time.

In a preferred embodiment of the invention, the process for detecting particles further comprises the sensor control unit 401 which controls the operation and the parameters of the two-dimensional sensor array 316 by providing a suitable ISO in a range of 500-5,000,000 and a suitable integration time in a range of 100-10,000 μs.

In a preferred embodiment of the invention, the sensor control unit 401 is integrated with the processor 400 or separated from the processor 400.

To gain a better understanding of the present invention, examples of the present invention will be given which are merely illustrative of the aspects of the invention and do not limit the scope of the present invention in any way.

### Example 1—the Device for Detecting Particles Using the Polarization and Light Absorption Properties

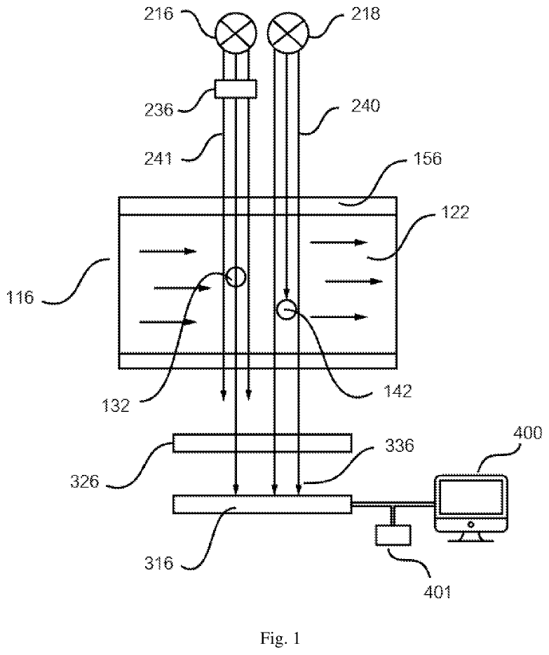

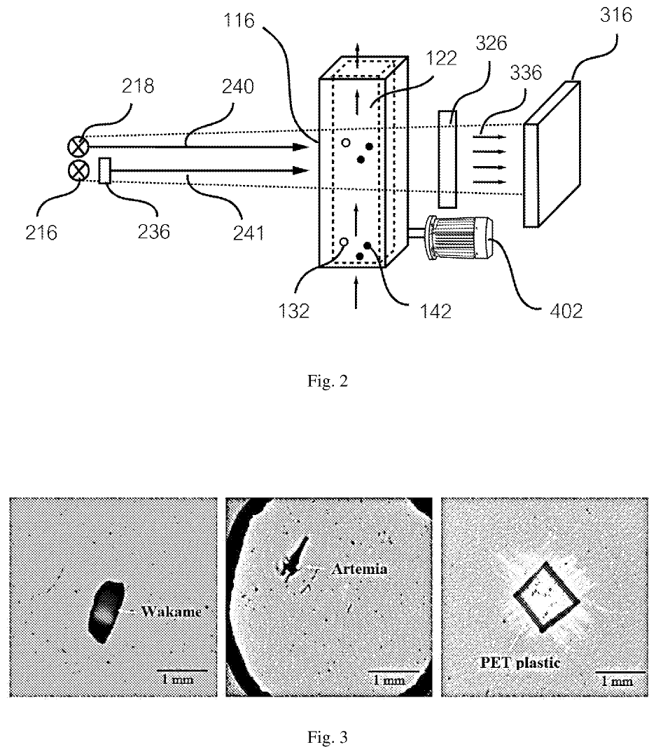

FIGS. 1 and 2 show examples of the diagram of the device for detecting particles in fluid according to the present invention which uses the polarization and light absorption properties, wherein the medium fluid 122 flows through or stays at rest in the detection region 116. The example according to the present invention uses the electromagnetic wave which is preferably the light wave, particularly any one of the green-light wave or the red-light wave. According to the present invention, the unpolarized parallel green-light wave is irradiated from the electromagnetic source 218 and the red-light wave is irradiated from the electromagnetic source 216. In front of said electromagnetic source 216, the first polarizing sheet 236 is provided to obtain the polarized electromagnetic wave 241 which, in this example, is the polarized red-light. The purpose of this example is to detect the microplastics and the plankton in sea water and produce an affordable device for detecting particles in fluid which can rapidly detect the particles, measure the particles having large difference in size, and classify the particles having different polarization properties.

The device for detecting particles in fluid according to the present invention uses the pump 402 to pump the medium fluid 122, which in this case is sea water comprising the particles 132, 142. The particle 132 represents the microplastic particle and the particle 142 represents the plankton particle. The medium fluid 122 flows through a rubber tube or a hose connected to the detection region 116 having the detection region wall 156 which has a light transmission property and can be obtained from a transparent or translucent material having no polarization property.

The device for detecting particles according to this example uses the electromagnetic sources 216, 218 to produce the electromagnetic wave, preferably the light wave, particularly any one of the green-light wave or the red-light wave. According to the present invention, the unpolarized parallel green-light wave is irradiated from the electromagnetic source 218 and the red-light wave is irradiated from the electromagnetic source 216, wherein the front region of said electromagnetic source 216 is equipped with the first polarizing sheet 236 to obtain the polarized electromagnetic wave 241 which in this example is the polarized red-light. Said electromagnetic sources 216, 218 are located away from the detection region 116 in a distance which produces parallel light waves towards said detection region 116, preferably at least 5 cm. The two-dimensional sensor array 316 which is the CMOS type is used to detect the electromagnetic wave 336 which is a transmitted light, an absorbed light, or a light with a change in polarization. Said sensor 316 is positioned opposite to the electromagnetic sources 216, 218. The second polarizing sheet 326 having a polarization axis making a 90° angle with the first polarizing sheet 236 is mounted in front of the electromagnetic source 216 of the red-light. Therefore, only the electromagnetic wave directly obtained from the electromagnetic source 240, which is the unpolarized green-light in this example, can travel to the two-dimensional sensor array 316, whereas the polarized electromagnetic wave 241 or the polarized red-light cannot travel through the second polarizing sheet 326.

FIG. 3 shows the test results of the detection of microplastic particles and the plankton particles. When the plankton particle 142 moves through the detection region, it absorbs the unpolarized green-light 240, resulting in shadow images of the plankton 142 on the two-dimensional sensor array 316 on the green background. The microplastic particle 132 which can change the polarization of light moves through the detection region 116 and cause the polarization axis of the red-light to change the direction, the microplastic particle 132 therefore can travel through the second polarizing sheet 326 and absorb the unpolarized green-light 240, causing a bright red image of the microplastic on the two-dimensional sensor array 316. Then, said sensor 316 transmits the data to the processor 400 which is a single-board computer, i.e., a computer in a single circuit board, and reports the results, which are the plankton concentration, the microplastic concentration, and the sea water volume used in the detection.

The data analysis is conducted using a Python programming to control the two-dimensional sensor array 316, process the data, and report the results. If only the plankton particle 142 is required to be detected or the microplastic particle 132 and the plankton particle 142 are required to be detected at the same time, the data analysis can be conducted using the same method with Example 1. After defining a boundary for the particles, a dark shadow represents the plankton particle 142, while the red color represents the microplastic particle 132.

If only the microplastic particle 132 is required to be detected, in order to be time efficient in the data processing, the detection is carried out by taking 30 frames using the two-dimensional sensor array 316 before determining an average to calculate the background data. Then, each frame is taken and only the frames with red pixels are chosen for the processing. The data of the frames chosen for the processing is then subtracted by the background data, which is referred to as the data which is different from the background. The boundary of the microplastics is defined from the region with the data which is different from the background that is higher than 25 from the maximum value of 255. The error is reduced by counting the regions which are close to each other more than the determined value as a single piece. The region which is smaller than the determined region is discarded. The detected fluid volume is calculated from the result of multiplication of the detected volume per frame with the number of frames taken, which includes the unprocessed frames. The detected volume per frame is calculated from the volume of the detection region, where the light travels therethrough and hits the image sensor. The result obtained is then processed.

### Example 2—Processing the Data Obtained from the Two-Dimensional Sensor Array

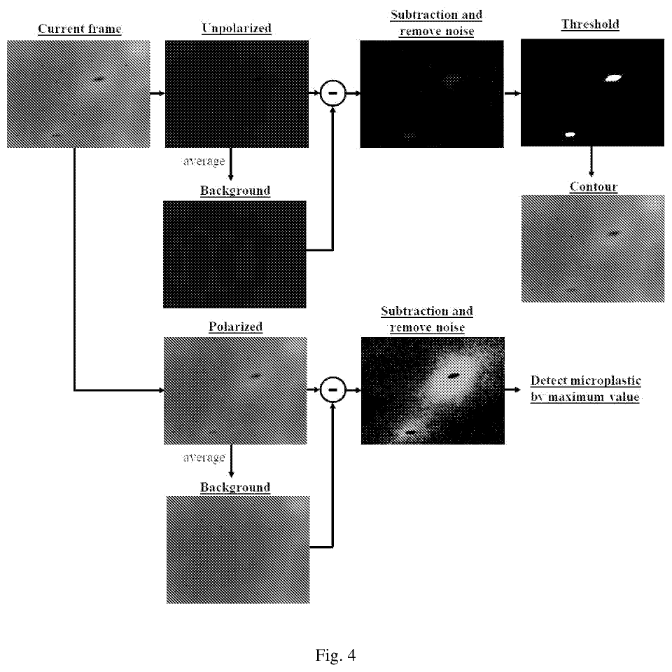

FIG. 4 shows an example of the processing of the data obtained from the two-dimensional sensor array. The processor 400 receives the data from the two-dimensional sensor array 316. Then, the analyses for the polarized channel and the unpolarized channel are conducted separately. The data processing is as follows.

For the unpolarized channel which in this case is the blue-light, calculating the background data when there are no particles 132, 142 to be detected by averaging from at least 30 frames then updating in a predetermined time or averaging and updating every frames (exponentially weighted moving average according to an equation:

$$New background data = ( 1 - k ) Old background data + k Processed frame$$

when k=0.03 being a weight of the new frame which does not count on the number of plankton in the first 30 frames in order to obtain the accurate background data. After 30 frames, the data from the sensor is brought to calculate an absolute difference (an integer) from the background data.

If the medium fluid flows through the detection region, the data of the frames chosen for the processing is then subtracted by the background data, which is referred to as the data which is different from the background. The boundary of the particles and/or fluid is defined from the region with the data which is different from the background which includes the regions which are close to each other more than the determined value as a single piece and discards the region which is smaller than the determined region. One or more of the data regarding shape and size of the boundary of the particles and/or fluid and the data which is different from the background in said boundary of the particles and/or fluid are used to compare with a specified database or model in order to classify types of the particles 132, 142 and/or fluid. The processor 400 calculates the volume of the medium fluid 122 which is detected by using the volume of the detection region where the electromagnetic wave travels therethrough and results of electromagnetic wave per particle and/or medium fluid 122 to be detected as the detected electromagnetic wave. The result obtained is then processed and reported.

For the polarized channel which in this case is the green-light for analyzing particles having the polarization axis distortion property, e.g., microplastic particles, the processing is conducted in the same manner as the unpolarized channel. The data of the frames chosen for the processing is subtracted by the background data. The image obtained from the processing shows green-light around the particles. This because the microplastic particles have the polarization axis distortion property.

Any improvements or modifications may be clearly understood and carried out by a person skilled in the art under the scope and spirit of the present invention as shown in the appended claims.

### BEST MODE OF THE INVENTION

Best mode of the invention is as described in the detailed description of the invention.

What is claimed is:

1. A device for detecting particles in fluid comprises
electromagnetic sources (216, 218) producing at least two different wavelengths and equipped with a first polarizing sheet (236) in a front region of any one of the electromagnetic sources (216, 218), an electromagnetic wave directly obtained from the electromagnetic source (240) and a polarized electromagnetic wave (241) irradiating a detection region (116);
the detection region (116) provided in the same area with or connected to a container containing a medium fluid (122) required in the detection, wherein said detection region (116) has a detection region wall (156), which allows the electromagnetic waves (240, 241) to irradiate therethrough and hit the particles (132, 142) detected in the medium fluid (122), and, next to the detection region (116), a second polarizing sheet (326) and a two-dimensional sensor array (316) provided in sequence, wherein the irradiation of the electromagnetic waves (240, 241) through the second polarizing sheet (326) produces an electromagnetic wave (336) used to irradiate the two-dimensional sensor array (316), said sensor (316) providing data which is transmitted to a processor (400);
the processor (400) provided to analyze the data obtained from the two-dimensional sensor array (316) from a single frame or multiple frames combined to detect the particles (132, 142) and subsequently report the results.

2. The device for detecting particles in fluid according to claim 1, wherein the electromagnetic waves (240, 241) are selected from any one or more of light wave, infrared wave, ultraviolet wave, microwave, X-ray wave, gamma ray, or a combination thereof.

3. The device for detecting particles in fluid according to claim 1, wherein the electromagnetic waves (240, 241) are preferably the light wave having a wavelength ranging from 350-800 nm.

4. The device for detecting particles in fluid according to claim 1, wherein the electromagnetic wave directly obtained from the electromagnetic source (240) is preferably any one of a red-light wave having a wavelength of 620-750 nm, a green-light wave having a wavelength of 500-620 nm, or a blue-light wave having a wavelength of 350-500 nm.

5. The device for detecting particles in fluid according to claim 1, wherein the polarized electromagnetic wave (241) is preferably any one of a red-light having a wavelength of 620-750 nm, a green-light wave having a wavelength of 500-620 nm, or a blue-light wave having a wavelength of 350-500 nm.

6. The device for detecting particles in fluid according to claim 1, wherein the electromagnetic sources (216, 218) produce wavelengths that are at least 10 nm different from one another.

7. The device for detecting particles in fluid according to claim 1, wherein the electromagnetic sources (216, 218) produce wavelengths that are different from one another in a range of 10-1,000 nm.

8. The device for detecting particles in fluid according to claim 1, wherein the electromagnetic sources (216, 218) produce the electromagnetic waves (240, 241) that are parallel or nearly parallel to one another, the electromagnetic source (216, 218) being selected from any one or more of halogen bulb, light bulb, laser, LED bulb, microwave sources, or a combination thereof.

9. The device for detecting particles in fluid according to claim 1, wherein the electromagnetic sources (216, 218) preferably adjust the electromagnetic waves (240, 241) such that they are parallel to one another using an optical composition selected from any one or more of lens, mirror, integrator rod, or a combination thereof.

10. The device for detecting particles in fluid according to claim 1, wherein a distance from the electromagnetic sources (216, 218) to the detection region (116) is 0-1,000 times greater than a thickness of the detection region to obtain the parallel or nearly parallel electromagnetic waves.

11. The device for detecting particles in fluid according to claim 1, wherein the electromagnetic sources (216, 218) are preferably 0-30 cm away from the detection region (116).

12. The device for detecting particles in fluid according to claim 1, wherein the electromagnetic waves (240, 241) from the electromagnetic sources (216, 218) are adjusted to have a suitable wavelength using the electromagnetic waves or the optical composition selected from any one or more of lens, mirror, filter, polarizer, prism, grating, slit, or a combination thereof.

13. The device for detecting particles in fluid according to claim 1, wherein the medium fluid (122) allows the electromagnetic waves to irradiate therethrough.

14. The device for detecting particles in fluid according to claim 1, wherein the medium fluid (122) contains different types of particles or fluid.

15. The device for detecting particles in fluid according to claim 1, wherein the medium fluid (122) has optical properties selected from any one or more of light absorption, light refraction, light reflection, fluorescence, light scattering, polarization, or a combination thereof.

16. The device for detecting particles in fluid according to claim 1, wherein the medium fluid (122) flows through or stays at rest in the detection region (116).

17. The device for detecting particles in fluid according to claim 1, wherein the particles (132, 142) have optical properties selected from any one or more of light absorption, light refraction, light reflection, fluorescence, light scattering, polarization, or a combination thereof.

18. The device for detecting particles in fluid according to claim 1, wherein the particles (132, 142) have a size ranging from 1 μm to 5 mm.

19. The device for detecting particles in fluid according to claim 1, wherein the detection region wall (156) is obtained from any one of transparent material or translucent material or a combination thereof.

20. The device for detecting particles in fluid according to claim 1, wherein the detection region wall (156) is preferably obtained from a material with no polarization axis distortion property.

21. The device for detecting particles in fluid according to claim 1, wherein the two-dimensional sensor array (316) is any one of a complementary metal oxide semiconductor (CMOS) or a charge coupled device (CCD) or a combination thereof.

22. The device for detecting particles in fluid according to claim 1, wherein the device for detecting particles in fluid further comprises at least one pump (402) which transmits the medium fluid (122) in a direction from the bottom to the top.

23. The device for detecting particles in fluid according to claim 1, wherein the device for detecting particles in fluid further comprises at least one pump (402) which draws the medium fluid (122) such that a flow direction of the medium fluid (122) makes a 0-45° angle with a gravity line in a position before the detection region (116).

24. The device for detecting particles in fluid according to claim 1, wherein the two-dimensional sensor array (316) transmits the data regarding any one of shape, size, intensity, wavelength, polarization, or a combination thereof to the processor (400) to detect the particles (132, 142).

25. The device for detecting particles in fluid according to claim 1, wherein the processor (400) is a device capable of analyzing the data, which is selected from any one or more of computer, mobile phone, cloud computing, application-specific integrated circuit (ASIC), field-programmable gate array (FPGA), embedded system, microcontroller, microprocessor, single-board computer, or a combination thereof.

26. The device for detecting particles in fluid according to claim 1, wherein the processor (400) processes and reports the data which are any one or more of types of particles, amount, volume, concentration, optical properties, phase of the particles (132, 142), or a combination thereof.

27. The device for detecting particles in fluid according to claim 1 further comprising a sensor control unit (401) which controls the operation and the parameters of the two-dimensional sensor array (316), which are ISO and integration time.

28. The device for detecting particles in fluid according to claim 1 further comprising the sensor control unit (401) which controls the operation and the parameters of the two-dimensional sensor array (316) by providing a suitable ISO in a range of 500-5,000,000 and a suitable integration time in a range of 100-10,000 μs.

29. The device for detecting particles in fluid according to claim 1 further comprising the sensor control unit (401) which is integrated with the processor (400) or separated from the processor (400).

30. A process for detecting particles comprising the steps as follows:
a. providing different types of particles (132, 142) in a medium fluid (122), which flows through or stays at rest in a detection region (156);
b. irradiating an electromagnetic wave directly obtained from the electromagnetic source (240) and a polarized electromagnetic wave (241) having different wavelengths at a detection region (116) through a detection region wall (156), which allows the electromagnetic waves (240, 241) to irradiate therethrough and hit the particles (132, 142) detected in the medium fluid (122);
c. measuring the electromagnetic wave from an optical interaction of the particles (132, 142) which hits the two-dimensional sensor array (316);
d. analyzing the data obtained from the two-dimensional sensor array (316) from a single frame of multiple frames combined using a processor (400) and reporting the results.

31. The process for detecting particles according to claim 30, wherein the electromagnetic waves (240, 241) are selected from any one or more of light wave, infrared wave, ultraviolet wave, or a combination thereof

32. The process for detecting particles according to claim 30, wherein the electromagnetic waves (240, 241) are preferably the light wave having a wavelength ranging from 350-800 nm.

33. The process for detecting particles according to claim 30, wherein the electromagnetic wave directly obtained from the electromagnetic source (240) is preferably any one of a red-light wave having a wavelength of 620-750 nm, a green-light wave having a wavelength of 500-620 nm, or a blue-light wave having a wavelength of 350-500 nm.

34. The process for detecting particles according to claim 30, wherein the polarized electromagnetic wave (241) is preferably any one of a red-light wave having a wavelength of 620-750 nm, a green-light wave having a wavelength of 500-620 nm, or a blue-light wave having a wavelength of 350-500 nm.

35. The process for detecting particles according to claim 30, wherein the electromagnetic sources (216, 218) produce wavelengths that are at least 10 nm different from one another.

36. The process for detecting particles according to claim 30, wherein the electromagnetic sources (216, 218) produce wavelengths that are different from one another in a range from 10-1,000 nm.

37. The process for detecting particles according to claim 30, wherein the electromagnetic sources (216, 218) produce the electromagnetic waves (240, 241) that are parallel or nearly parallel to one another, the electromagnetic sources (216, 218) being selected from any one or more of laser, diode, LED bulb, or a combination thereof.

38. The process for detecting particles according to claim 30, wherein the electromagnetic sources (216, 218) preferably adjust the electromagnetic waves (240, 241) such that they are parallel to one another using an optical composition selected from any one or more of lens, mirror, integrator rod, or a combination thereof.

39. The process for detecting particles according to claim 30, wherein a distance from the electromagnetic sources (216, 218) to the detection region (116) is 0-1,000 times greater than a thickness of the detection region to obtain the parallel or nearly parallel electromagnetic waves.

40. The process for detecting particles according to claim 30, wherein the electromagnetic sources (216, 218) are at least 5 cm away from the detection region (116).

41. The process for detecting particles according to claim 30, wherein the electromagnetic sources (216, 218) are preferably 0-30 cm away from the detection region (116).

42. The process for detecting particles according to claim 30, wherein a distance from the electromagnetic sources (216, 218) to the detection region (116) is more than three times greater than a thickness of the detection region to obtain the parallel or nearly parallel electromagnetic waves.

43. The process for detecting particles according to claim 30, wherein the electromagnetic waves (240, 241) from the electromagnetic sources (216, 218) are adjusted to have a suitable wavelength using the electromagnetic waves or the optical composition selected from any one or more of lens, mirror, filter, polarizer, prism, grating, slit, or a combination thereof.

44. The process for detecting particles according to claim 30, wherein the medium fluid (122) allows the electromagnetic waves to irradiate therethrough.

45. The process for detecting particles according to claim 30, wherein the medium fluid (122) contains different types of particles or fluid.

46. The process for detecting particles according to claim 30, wherein the medium fluid (122) has optical properties selected from any one or more of light absorption, light refraction, light reflection, fluorescence, light scattering, polarization, or a combination thereof.

47. The process for detecting particles according to claim 30, wherein the medium fluid (122) flows through or stays at rest in the detection region (116).

48. The process for detecting particles according to claim 30, wherein the particles (132, 142) have optical properties selected from any one or more of light absorption, light refraction, light reflection, fluorescence, light scattering, polarization, or a combination thereof.

49. The process for detecting particles according to claim 30, wherein the particles (132, 142) have a size ranging from 1 μm to 5 mm.

50. The process for detecting particles according to claim 30, wherein the detection region wall (156) is obtained from any one of transparent material or translucent material or a combination thereof.

51. The process for detecting particles according to claim 30, wherein the detection region wall (156) is preferably obtained from a material with no polarization axis distortion property.

52. The process for detecting particles according to claim 30, wherein the two-dimensional sensor array (316) is any one of a complementary metal oxide semiconductor (CMOS) or a charge coupled device (CCD) or a combination thereof.

53. The process for detecting particles according to claim 30 further comprising a step of transmitting the medium fluid (122) using at least one pump (402) in a direction from the bottom to the top.

54. The process for detecting particles according to claim 30 further comprising a step of transmitting the medium fluid (122) using at least one pump (402) such that a flow direction of the medium fluid (122) makes a 0-45° angle with the gravity line in a position before the detection region (116).

55. The process for detecting particles according to claim 30, wherein the two-dimensional sensor array (316) transmits the data regarding any one of shape, size, intensity, wavelength, polarization, or a combination thereof to the processor (400) to detect the particles (132, 142).

56. The process for detecting particles according to claim 30, wherein the data obtained from the two-dimensional sensor array (316) is the data obtained from the electromagnetic wave (326).

57. The process for detecting particles according to claim 30, wherein the two-dimensional sensor array (316) transmits the data regarding any one of shape, size, intensity, wavelength, polarization, or a combination thereof to the processor (400) to detect the particles (132, 142).

58. The process for detecting particles according to claim 30, wherein the processor (400) is a device capable of analyzing the data, which is selected from any one or more of computer, mobile phone, cloud computing, application-specific integrated circuit (ASIC), field-programmable gate array (FPGA), embedded system, microcontroller, microprocessor, single-board computer, or a combination thereof.

59. The process for detecting particles according to claim 30, wherein the processor (400) processes and reports the data which are any one or more of types of particle, amount, volume, concentration, optical properties, phase of the particles (132, 142), or a combination thereof.

60. The process for detecting particles according to claim 30 further comprising a sensor control unit (401) which controls the operation and the parameters of the two-dimensional sensor array (316), which are ISO and integration time.

61. The process for detecting particles according to claim 30 further comprising the sensor control unit (401) which controls the operation and the parameters of the two-dimensional sensor array (316) by providing a suitable ISO in a range of 500-5,000,000 and a suitable integration time in a range of 100-10,000 μs.

62. The process for detecting particles according to claim 30 wherein sensor control unit (401) is integrated with the processor (400) or separated from the processor (400).
